(19) United States
(12) Patent Application Publication
(10) Pub. No.: US 2011/0045422 A1
(43) Pub. Date: Feb. 24, 2011

(54) OPTICAL FLUE GAS MONITOR AND CONTROL

(75) Inventor: Michael C. Tanca, Tariffville, CT (US)

Correspondence Address: ALSTOM Power Inc., 200 Great Pond Drive, P.O. Box 500, WINDSOR, CT, 06095, US

(73) Assignee: ALSTOM TECHNOLOGY LTD, Baden (CH)

(21) Appl. No.: 12/545,134

(22) Filed: Aug. 21, 2009

(51) Int. Cl. F23N 1/02; F23N 5/00; F23J 15/02; G01N 21/00

(52) U.S. Cl. 431/76; 431/12; 110/203; 110/215; 110/345; 73/23.31

(57) ABSTRACT

A plurality of optical monitoring systems 220,320 sense the concentration of at least one constituent in flue gasses of a furnace 1 and its emission control devices. The monitoring devices 220,320 includes at least one optical source 221 for providing beams 223 through a sampling zone 18 to create a combined signal indicating the amount of various constituents within the sampling zone 18. The combined signal may be fed forward to emission control devices to prepare them for oncoming emissions. The combined signals may also feed backward to adjust the emission control devices. They may also be provided to a control unit 230 to control stoicheometry of the burners of furnace 1. This results in a more efficient system that reduces the amount of emissions released.

### CROSS REFERENCE TO RELATED APPLICATIONS

This application is related to co-pending U.S. patent application entitled “BURNER MONITOR AND CONTROL” by the same inventor, Michael Tanca, filed on the same day as the present application. This applications incorporates the above-referenced application as if it were set forth in its entirety herein.

### BACKGROUND OF THE INVENTION

1. Field of the Invention

This invention relates to coal-fired combustion systems, and more particularly to a flue gas monitoring system for accurate control of emissions of coal-fired combustion systems.

2. Description of the Related Art

In various coal-fired combustion systems, combustion is monitored by a measurement device located in the rear of the furnace. Typically, this is an oxygen sensor. This measurement device provides feedback signals that are used to control the combustion within the combustion system. These sensors tend to be inaccurate since they only measure O₂ at a specific sensor location. It would be more accurate to measure O₂ at a number of locations.

Some systems, especially mechanical systems, take some time to react. In a standard system, a measurement device identifies properties of the flue gasses, and then reacts based upon the identified properties. If one of the properties measured is a high concentration of an emission gas, the appropriate pollution control system reacts to reduce the concentration of the gas before it leaves the combustion system. There is some lag time between when the gas being detected and when the gas concentration is actually reduced. It would be beneficial for systems, such as the emission control system, to receive an advance notice of the measured properties of the flue gas so that it may “ramp up” and reduce the system lag time.

Thus, what are needed are methods and apparatus for accurate measurements of combustion conditions throughout a sampling zone associated with a boiler combustion system. Preferably, the measurements provide for improved control thus leading to improved efficiency.

### BRIEF SUMMARY OF THE INVENTION

The invention may be embodied as an efficient combustion system 1000 for monitoring a property of at least one constituent in flue gas from a furnace 1 which burns solid fuel, primary air and secondary air, the apparatus having an optical monitoring device 220.

The optical monitoring device 220 including a plurality of optical sources 221 for providing optical beams 223 through the flue gasses in a sampling zone 18.

A number of detectors 222 each detect an optical beam 223 and provide a sensed signal.

An electronics unit 225 is coupled to the detectors 222 and configured to combine the sensed signals from the detectors 222 to estimate a property of at least one constituent in the sampling zone 18 and use the estimate to adjust the operation of the furnace 1.

A control unit 230 is coupled to the optical monitoring device 220 and receives the combined signal. It controls the flow of the fuel feed 5, primary air feed 6 and secondary air feed 7 to the furnace 1 based upon the need indicated in the combined signal.

The invention may also be embodied as an efficient combustion system 1000 having a furnace 1 for creating flue gasses having an upstream optical monitoring device 220 for sampling the flue gasses and for a concentration of a first constituent at its location and creating an upstream concentration signal.

It includes a downstream optical monitoring device 320 for sampling the flue gasses and for the first constituent and creating a downstream concentration signal indicating the concentration of the first constituent in the flue gas at its location.

An emission control system 300 capable of reducing the concentration of the first constituent in the flue gasses is located between, and coupled to the monitoring devices 220, 320. The emission control system 300 receives flue gasses and the emission control device receives the upstream concentration signal and uses it to adjust its future operation on future flue gas concentrations to be received, and uses the downstream concentration signal to adjust its current operation.

The invention may further be embodied as an efficient combustion system 1000 having a furnace 1 for creating flue gasses and a number of serially connected emission control systems. The emission control systems and the furnace are connected by ducts;

A control unit 230 is coupled to the furnace and operates to control fuel flow, primary air and secondary air to the furnace 1.

The system includes at least one monitoring device 220 having a number of optical sources 221 with each optical source 221 passing an optical beam through the flue gasses to a corresponding detector 222. Each detector 222 creates a number of sensed signals, the sensed signals are combined to provide a signal indicating the concentration of a constituent in the flue gasses. The monitoring system sends the combined signal to the control unit 230 to control furnace 1 to minimize the concentration of the constituent emitted in the flue gasses.

Optionally, several monitoring devices are used to sample one or more constituents throughout the system. These may be used to as a feed forward signal to give advance notice of emission concentrations to downstream emission control devices, or provide feedback to upstream emission control devices.

In addition, the feedback signals may be sent to a controller 230 that controls the operation of the furnace 1, and adjust oxygen concentration and/or combustion temperature to regulate NOx and mercury emissions.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a schematic diagram of a portion of a prior art combustion system;

FIG. 2 depicts a schematic diagram of a portion of one embodiment of a combustion system according to the present invention;

FIG. 3 depicts a cross sectional view of a duct illustrating an embodiment of a combustion monitoring system according to the present invention; and

FIG. 4 depicts a schematic block diagram of one embodiment of the present invention incorporated into a combustion system having several emission control devices.

### DETAILED DESCRIPTION OF THE INVENTION

Disclosed is a method and apparatus for providing for accurate monitoring of combustion conditions, flue gas constituents from a combustion system, and controlling the combustion system and/or emission control devices based upon the monitoring. In various non-limiting embodiments provided herein, the combustion system is a solid fuel, gaseous or liquid fuel fired combustion system. The combustion system may be a combination furnace and boiler, or steam generator. One skilled in the art will recognize, however, that the embodiments provided are merely illustrative and are not limiting of the invention.

The methods and apparatus make use of optical detection systems. As provided herein, the optical signaling and detection systems are simply referred to as a “monitoring system.” In general, the monitoring system includes a variety of components for performing a variety of associated functions. The components may include a plurality of optical sources such as lasers, a plurality of sensors, a control unit, computer components, software (i.e., machine executable instructions stored on machine readable media), signaling devices, motor operated controls, at least one power supply and other such components. The monitoring system provides for a plurality of measurements of at least one gas constituent relative to a sampling zone. The plurality of measurements provide for, among other things, measurement of gas constituents in the sampling zone, such as in relation to a burner (i.e., a nozzle). The measurements may be performed in multiple locations by use of optical sensing technology, thus providing a localized, more responsive measure of fuel combustion. Of course, the monitoring system may also be viewed as a control system. More specifically, measurement data from the monitoring system may be used to control aspects of the combustion system and the emission control devices. Accordingly, for at least this reason, the monitoring system may be considered as a control system or at least as a part of a control system.

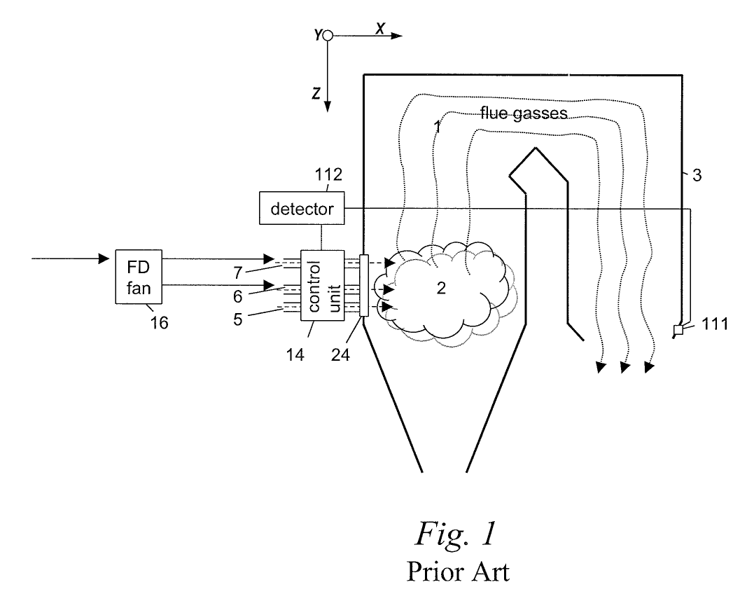

Turning now to FIG. 1, there is shown a side elevational view of a portion a prior art furnace 1. The emission control devices are not shown here. A solid fuel, such as pulverized coal is entrained in a jet of primary air and provided to a combustion chamber 2 through a control unit 14.

A forced draft (FD) fan 16 provides the primary air as well as secondary air also provided to control unit 14 into a secondary air inlet 7. The air and fuel is combusted in a combustion chamber 2. Hot flue gasses are created and pass out of a backpass 3.

Throughout directions such as “downstream” means in the general direction of the flue gas flow. Similarly, the term “upstream” is opposite the direction of “downstream” going opposite the direction of flue gas flow.

An oxygen (O₂) sensor 111 senses the oxygen concentration and passes the signal to a detector 112 to identify if the O₂ is at the proper level. If not, detector 112 causes control unit 14 to adjust fuel flow, primary airflow and secondary airflow.

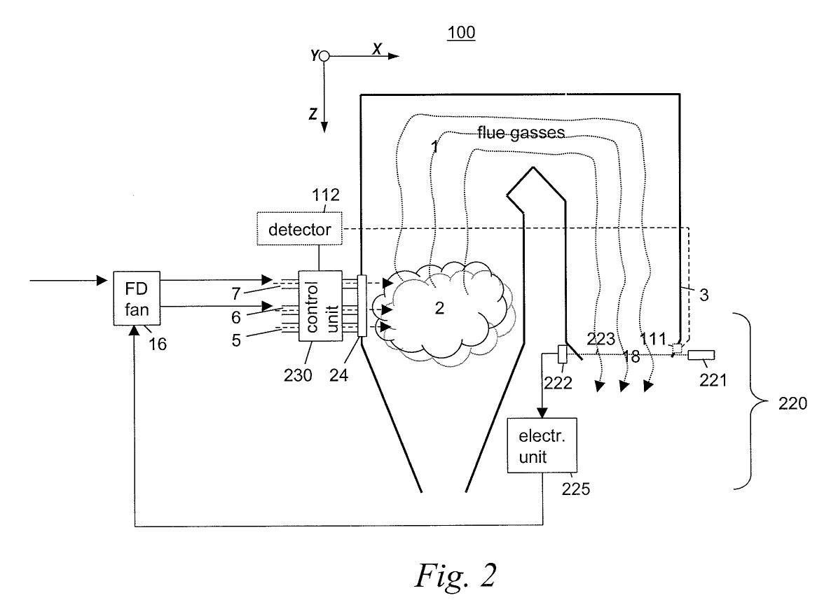

FIG. 2 shows a portion of a furnace 1 fitted with a monitoring device 220. A control unit 230 with additional functionality as described below, replaces control unit 14 and is employed to control the fuel feed 5, the primary air feed 6 and the secondary air feed 7 to all of the burners 24 of furnace 1.

In addition to the parts described in connection with FIG. 1, it includes a plurality of optical sources 221, which may be optical sources that pass through a portion of a flue duct, referred to as a sampling zone 18.

The optical sources 221 provide optical beams 223 that pass through the flue gasses and the sampling zone 18 and are detected by a corresponding plurality of detectors 222. As the beams pass through the flue gasses, there is absorption of various wavelengths characteristic of the constituents within the flue gasses.

The optical sources 221 are coupled to an electronics unit 225 to provide for characterization of received optical signals and identify the constituents, their concentrations and other physical aspects of substances in the flue gasses. The electronics unit 225 provides for estimations of physical aspects of the sampling zone 18 between the optical sources 221 and the corresponding detector 222.

The present invention uses optical sources 221, and detectors 222 for measurement and assessment of gas species such as carbon monoxide (CO), carbon dioxide (CO₂), mercury (Hg), sulfur dioxide (SO₂), sulfur trioxide (SO₃), nitrogen dioxide (NO₂), nitrogen trioxide (NO₃) and oxygen (O₂) present in the sampling zone 18. SO₂ and SO₃ are collectively referred to as SOx. Similarly, NO₂ and NO₃ are collectively referred to as NOx.

In one embodiment of the present invention, optical source 221 and detector 222 and electronics unit 225 replace the function of the O₂ sensor 111 and control unit 14.

In an alternative embodiment on the present invention, optical source 221 and detector 222 and electronics unit 225 supplement the function of the O₂ sensor 111 and control unit 14.

In various embodiments, the monitoring device 220 provides for measuring the localized gas constituents and providing at least one of a monitored signal that may be fed backward to the furnace 1 to control combustion.

The signals may also be fed forward to the emission control devices to provide advance notice of the constituents (pollutants) in the flue gas so that they may quickly ‘ramp up’ to remove the constituents.

As a non-limiting example, depending on the situation, fuel and/or airflow from a fuel feed 5, primary air feed 6, and secondary air feed 7 can be modulated to give optimum furnace combustion and/or environmental performance. Also, the overall combustion air provided to the system may be controlled by adjusting FD fan 16. Accordingly, use of the feedback signal and/or feed forward signal permits the system to adjust combustion and operation of emission control devices.

For convenience of explanation, the monitoring device 220 may be regarded as producing “measurement data,” “monitoring data,” “characterization data” and the like. Each of the feedback signal and the feed-forward signal as may be generated by the monitoring device 220 include forms of such data.

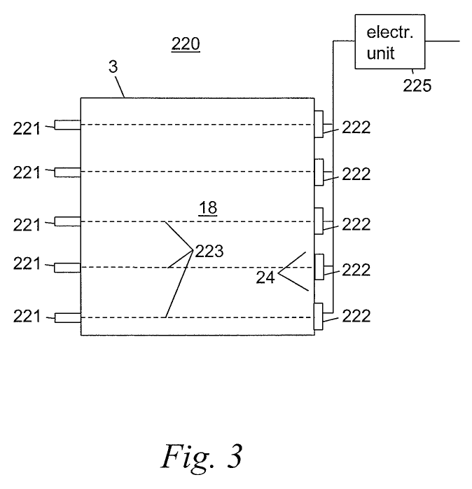

FIG. 3 depicts a cross sectional view of a duct illustrating an embodiment of the combustion monitoring device 220 according to the present invention.

As the flue gasses are passed through the backpass 3 (duct), optical sources 221 pass beams 223 through the sampling zone 18 to detectors 222. Constituents in the flue gasses absorb different wavelengths. Therefore, optical sources 221 must be selected to transmit within the absorption band of the constituents intended to be measured. Therefore, if O₂ is the constituent to be measured, there must be a laser 221 that transmits within the frequency band that covers the frequency band characteristically absorbed by O₂.

The problem with prior art sensors is that they would only provide point measurements at specific locations. Many sensors would be required to provide an accurate overall reading. This would be costly and not feasible. The present invention samples along several beams 223 through the sampling zone. The readings sensed by the detectors 222 are averaged to provide a more accurate representation of an average concentration of a constituent over the sampling region 18.

Optionally, some readings may be weighted more than others. For example, readings from a beam 223 passing through the center of the sampling region 18 may be weighted more than one that is on the periphery.

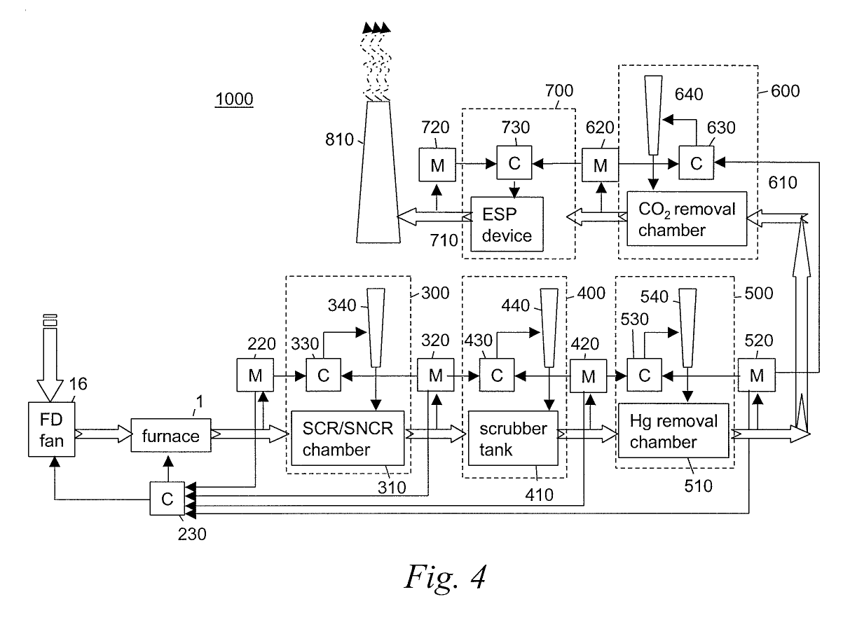

Similarly, the monitoring device 220 may be modified to detect SO₂, SO₃, mercury gas, NO₂, NO₃, CO₂ and other emissions, as commonly known in the art. These will be discussed with reference to FIG. 4.

The electronic unit 225 receives the signals from the detectors 222 and calculates the presence and amount of various entities. For example, electronics unit 225 may calculate the attenuation of characteristic frequencies to result in an absorption spectrum. This spectrum may match, for example, O₂ in the flue gas. The degree of optical absorption relative to the overall received signal will then indicate the concentration of O₂, as well known in the art.

Based upon the calculated amount of a given entity, or ratios of several entities, an action may be determined. For example, if too much O₂ is detected in the flue gas, FD fan 16 of FIG. 2 may be slowed or the air diverted to reduce the amount of air and O₂ provided to the system.

In the embodiment shown, all optical sources 221 are parallel to each other and have the same distance between the optical sources 221 and their corresponding detectors 222.

The optical sources 221 may optionally be placed at other orientations and have differing distances between them. In such a case, the electronics unit 225 should have prestored information as to the distance between each laser 221 and its corresponding detector 222. The space between the source and detector indicates the amount of intervening constituents absorbing light. Therefore, if different laser 221, detector 222 have different distances between them, the readings should be adjusted accordingly.

The estimations of concentrations and other physical properties may be performed using techniques as are known in the art. Exemplary techniques include evaluation of signal attenuation, signal absorption, fluorescence and other forms of wavelength shifting, scatter and other such techniques.

FIG. 4 depicts a schematic block diagram of one embodiment of the present invention incorporated into a combustion system having several pollution control devices.

The combustion device 1 burns fuel and creates flues gases that are passed downstream to emission control devices. These may be a selective catalytic reduction (SCR) system and/or a selective non-catalytic reduction (SNCR) system 300 providing a flow of ammonia and/or amines to reduce NO₂, NO₃ in the flue gasses, a scrubber system 400 to remove SO₂, SO₃ from the flue gasses, a mercury (Hg) control system 500 that uses activated carbon or additive to remove mercury gas species from the flue gas, and a particulate removal system 600 that removes particulate matter from the flue gas. In this embodiment, an Electrostatic Precipitator (ESP) is used, however any type of particulate removal equipment may be used. A stack 810 regulates the flow of flue gas exiting the system.

The first monitoring device 220 discussed above is placed just downstream from furnace 1. Monitor device 220, 320, 420, 520, 620, 720 may be constructed to monitor gas constituents such as O₂, CO₂, SOₓ, NOₓ, Hg, unburned fuel and particulate matter. Control systems 330, 430, 530 function in combination with other equipment to control the release of the monitored constituents.

If there is an unusually large amount of any of these constituents created, the appropriate downstream control unit 330, 430, 530, 630 should have advance notice to handle the large concentration of constituents. This allows the emission control systems time to prepare and react.

Therefore, monitoring devices 220, 320, 420, 520, 620 provide feed-forward signals to downstream elements. Similarly, monitoring devices 220, 320, 420, 520, 620 and 720 also provide a feedback signal to upstream control devices 230, 330, 430, 530, 630 and 730 so that the emission control devices can examine how well they had controlled emissions of a constituent and adjust accordingly. Each will be described separately below.

Monitor devices 320, 420, 520, 620 and 720 can be constructed similar to monitor device 220 shown in FIG. 3, to monitor different cross-sectional sampling zones 18 in the flue gas flow. Since monitor device 720 is measuring particulate matter in the flue gasses, it measures laser transmission through the flue gasses as opposed to looking at absorption spectra.

Monitoring device 220 provides a feedback signal to control unit 230 to further adjust the FD fan 16 input and operating parameters of furnace 1, such as fuel flow, primary air flow and secondary air flow. For example, monitor 220 monitors at least one of O₂, CO, CO₂, NOₓ, Hg, and unburned fuel and provides a signal indicating how to adjust the air input to the system from FD fan 16. It may also provide a signal to furnace 1 indicating how to adjust the primary airflow and secondary airflow. Usually this is done by adjusting air dampers and fuel flow valves.

Monitor device 220 also monitors NOx levels and provides these levels in a feed forward signal to controller 330. These NOx levels provide an advance indication to controller 330 and injector 340 of the approximate amount of amines to inject into SCR/SNCR 310. Monitor device 220 may also send O₂ levels that may also provide an indication of what is to follow.

Monitor device 320 monitors the NOx constituents downstream of an SCR/SNCR system 300 having a SCR/SNCR chamber 310. Monitor device 320 provides a feedback signal to a control unit 330 of the SCR/SNCR system 300 to indicate NOx levels downstream of SCR chamber 310. Controller 330 then re-adjusts the amount of material provided by a tank 340 based upon the input from monitoring device 320 and optionally, the input from monitoring device 220.

Monitoring device 320 may also measure SOₓ emissions and provides a feed-forward signal to a control unit 430 of a scrubber system 400 indicating the amount of SOₓ that scrubber system 400 will be experiencing soon.

Similarly, monitoring device 420 will monitor the SOₓ levels in the flue gasses leaving a scrubber tank 410. The signal having the SOx levels is provided to control unit 430 to actuate a sprayer 440 to re-adjust an amount of limestone slurry, or a dry alkaline agent sprayed into scrubber tank 410 for reducing SOx emissions.

Control unit 430 may also take into account the forward feed signal provided by monitoring device 320.

Similarly, control unit 530 of Hg removal system 500 may receive a feed forward signal from monitoring device 420 indicating upstream Hg levels and a feed back signal from monitor device 520 indicating downstream Hg levels. Control unit 530 calculates an adjustment to an injector 540 to adjust the amount of adsorbent introduced into Hg removal chamber 510 based upon the inputs received.

Monitoring devices 520, 620 may also detect CO₂ levels upstream and downstream, respectively and provide signals indicating the detected levels to a control unit 630 of a CO2 removal system 600. Control unit 630 then calculates the proper amount of material (chilled ammonia or other CO2 removal material) to inject to remove the CO₂ from the flue gasses. Control unit 630 actuates an injector 640 of CO2 removal system 600 to inject the proper amount of material.

Monitor devices 620, 720 monitor the amounts of particulate material being released upstream and downstream of particulate removal system 700 and provides signals indicating these levels. These signals are provided to another control unit 730 of particulate removal system 700 that may provide adjustments to a particulate removal device such as an electrostatic precipitator (ESP) 710 shown in this embodiment. Optionally, it may restrict or reroute flue gasses through another particulate removal device (not shown) until enough of the particulate material has been removed, based upon input from monitor devices 620, 720.

The feed forward signals were described as being from a constituent monitored immediately upstream from the device receiving the signal. It is to be understood that a feed forward signal from a constituent monitored in the flue gasses may be sent to one or more devices device located anywhere downstream. Similarly, a feedback signal from a constituent monitored in the flue gasses may be sent to one or more devices located anywhere upstream.

The monitored signals are used by the pollution control devices to optimize the use of fuel, ammonia, amines, sorbent and/or other additives to reduce the release of pollutants. This can provide for substantial improvements in performance and/or operating costs of the furnace 1.

Many prior art systems have tried to optimize each of the pollution control devices independently. However, one or parameters may affect several type of emission. Therefore, optimizing several emission control devices simultaneously has a greater effect on the entire system than optimizing all emission control devices independently.

It is known that the amount of NOx emissions are dependent upon the amount of oxygen present during combustion. The amount of oxygen present in combustion also has an effect on the amount of Hg emitted.

Similarly, the amount of NOx and mercury emitted are highly dependent upon the temperature of combustion. Therefore, by adjusting the amount of oxygen in the furnace 1 or by adjusting the temperature of furnace 1, the amounts of NOx and mercury can be adjusted.

Monitoring devices 220, 320 measure the upstream and downstream NOx concentrations relative to the SCR/SNCR removal system 300. A signal indicating the upstream NOx concentration is provided by monitoring device 220 to control unit 230. Similarly, a signal indicating the downstream NOx concentration is provided by monitoring device 320.

Similarly, monitoring devices 420, 520 measure the upstream and downstream mercury concentrations relative to the mercury removal system 500. A signal indicating the upstream mercury concentration is provided by monitoring device 420 to control unit 530. Similarly, a signal indicating the downstream mercury concentration is provided by monitoring device 520.

Control device 230 is adapted to calculate stoicheometry of fuel flow, primary air flow, and secondary air flow for various burners and burner levels to provide an optimum amount of oxygen used and an optimum combustion temperature to minimize both the NOx and the mercury emitted.

Having thus described aspects of the present invention, one skilled in the art will recognize that features of merit in the invention include, without limitation: use of a grid of optical sources directly above the burner level to measure gas constituents from furnaces; an optical monitoring design for furnaces that can be used at each burner level or above each burner level that measures gas species to control the local burner stoichiometry; ability to control combustion within the furnace using laser grid measurement; primary control of boiler combustion using optical sources at the furnace outlet to control air feeds to the burners; an improved, non-grid design to measure gas constituents at the flue gas outlet; control of downstream emission control systems using laser grid measurements; use of NOₓ measurements in the furnace as a feed-forward signal to govern the flow feed rate of ammonia or amines to an SCR or a SNCR; as well as use of SOₓ and CO₂ measurements in the furnace as a monitored signal fed forward to govern feed rate of sorbent to a scrubber; laser measurements for the removal of mercury and laser control of acquisition of CO₂ constituents.

It should be recognized that the monitoring device 220 may be deployed as multiple monitoring systems. Further, the monitoring device 220 may be used anywhere in the stream of fuel, air, combustion and/or exhaust to achieve the desired level of control. Further, optical beams 123 may be generated which are described in two or three dimensions.

The optical sources may be any lasers that transmit light in a band useful in detecting desired constituents in the flue gasses. This may include lasers of all types of gasses and species. Detection techniques may be based on modulation of signal frequency or signal wavelength as well as signal attenuation. In general, embodiments of the monitoring device 220 include apparatus that measure gas concentrations by shining the laser beam through a sample of gas and measuring the amount of laser light absorbed. However, the optical source and detector wavelengths can be tuned to detect absorption at a variety of wavelengths. These properties give laser detectors a good combination of properties, including selectivity and sensitivity.

Advantages of laser monitoring include an ability to characterize the gas constituents. That is, a tunable laser generally emits light in the near infrared (NIR) region of the electromagnetic spectrum. Many of the combustion gases absorb light in NIR, and may be characterized by a number of individual “absorption lines.” A tunable laser can be tuned to select a single absorption line of a target gas, which does not overlap with absorption lines from any other gases. Therefore, laser gas sensing can be considered selective with regard to sampling of gases. A variety of other technical advantages is known to those skilled in the art. Further, tunable lasers are relatively inexpensive. Accordingly, the monitoring device 220 is cost effective and easy to maintain.

Exemplary tunable lasers are produced by Aegis Semiconductors, Inc. of Woburn, Mass. One non-limiting example of a thermally tunable optical filter is disclosed in the U.S. Patent Application Publication No.: US/2005/0030628 A1, entitled “Very Low Cost Narrow Band Infrared Sensor,” published Feb. 10, 2005, the disclosure of which is incorporated by reference herein in it's entirety. This application provides an optical sensor for detecting a chemical in a sample region that includes an emitter for producing light, and for directing the light through the sample region. The sensor also includes a detector for receiving the light after the light passes through the sample region, and for producing a signal corresponding to the light, the detector receives. The sensor further includes a thermo-optic filter disposed between the emitter and the detector. The optical filter has a tunable passband for selectively filtering the light from the emitter. The passband of the optical filter is tunable by varying a temperature of the optical filter. The sensor also includes a controller for controlling the passband of the optical filter and for receiving the detection signal from the detector. The controller modulates the passband of the optical filter and analyzes the detection signal to determine whether an absorption peak of the chemical is present.

One skilled in the art will recognize that the foregoing is merely one embodiment of the laser 121, and that a variety of other embodiments may be practiced. Accordingly, it should be recognized that the term “optical” makes reference to any wavelength of electromagnetic radiation useful for practice of the teachings herein. In general, the electromagnetic radiation may include a wavelength, or band of wavelengths that are traditionally considered to be at least one of microwave, infrared, visible, ultraviolet, X-rays and gamma rays. However, in practice, the wavelength, or band of wavelengths selected for an optical signal are generally classified as at least one of infrared, visible, ultraviolet, or sub-categories thereof.

Further, one should recognize that the laser 21 generally provides light amplification by stimulated emission of radiation. That is, a typical laser emits light in a narrow, low-divergence monochromatic beam with a well-defined wavelength. However, such as restriction is not necessary for practice of the teachings herein. In short, any optical beam that exhibits adequate properties for estimating measurement data may be used. Determinations of adequacy may be based upon a variety of factors, including perspective of the designer, user, owner and others. Accordingly, the laser 21 need not precisely exhibit lasing behavior, as traditionally defined.

The present invention may be provided as part of a retrofit to existing combustion systems. For example, the monitoring and control system 100 may be mounted onto existing components and integrated with existing controllers. Accordingly, a system making use of the teachings herein may also include computer software (i.e., machine readable instructions stored on machine readable media). The software may be used as a supplement to existing controller software (and/or firmware) or as an independent package.

Further, a kit may be provided and include all other necessary components as may be needed for successful installation and operation. Example of other components include, without limitation, electrical wiring, power supplies, motor and/or manually operated valves, computer interfaces, user displays, assorted circuitry, assorted housings, relays, transformers, and other such components.

Accordingly, provided is a combustion system that includes at least one optical detector at the boiler outlet to measure the gas species, such as oxygen. The purpose of both systems in both locations is, among other things, to control the overall airflow to the boiler with the laser at the boiler outlet and to provide a local control of the boiler burners with the use of the optical sources mounted proximate to each burner.

Software may be used in the functioning and operation of various parts of the present invention. For example, electronics unit (102 of FIGS. 1, 2) and control unit of FIGS. 1, 3 may employ such software. This software may be provided in conjunction with a computer readable medium, may include any type of media, such as for example, magnetic storage, optical storage, magneto-optical storage, ROM, RAM, CD ROM, flash or any other computer readable medium, now known or unknown, that when executed cause a computer to implement the method and operate apparatus of the present invention. These instructions may provide for equipment operation, control, data collection and analysis and other functions deemed relevant by a user.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An efficient combustion system for monitoring a property of at least one constituent in flue gas from a furnace that burns solid fuel, primary air and secondary air, the apparatus comprising:
an optical monitoring device comprising:
a plurality of optical sources for providing optical beams through the flue gasses in a sampling zone, and
a plurality of detector, each for detecting an optical beam and for providing a sensed signal,
an electronics unit coupled to the detectors configured to combine the sensed signals from the detectors to provide a combined signal having an estimate a property of at least one constituent in the sampling zone from the signals received and use the estimate to adjust the operation of the furnace 1; and
a control unit coupled to the optical monitoring device, adapted to receive the combined signal and control a flow of at least one of a fuel feed, a primary air feed and a secondary air feed to said furnace based upon the combined signal.

2. The efficient combustion system as in claim 1, wherein the at least one optical source comprises a laser.

3. The efficient combustion system as in claim 1, wherein the constituent is selected from the group consisting of:
sulfur dioxide (SO₂), sulfur trioxide (SO₃), nitrogen dioxide (NO₂), nitrogen trioxide (NO₃), mercury (Hg) and carbon dioxide (CO₂), mercury (Hg) and suspended particulates.

4. The efficient combustion system as in claim 1, wherein the property comprises at least one of a presence, a quantity, a density, a concentration of said constituent and a rate of change of any of these properties.

5. The efficient combustion system as in claim 4, further comprising at least one an emission control system from the group consisting of:
a selective catalytic reduction (SCR) system, a selective non-catalytic reduction (SNCR) system, a scrubber system, a mercury control system, a CO₂ removal system, and a particulate removal system; and
at least one additional optical monitoring device for creating a second combined signal indicating a property of at least one constituent in flue gas in the emission control system and using the second combined signal to adjust the operation of at least one of the furnace operation and the emission control system.

6. The efficient combustion system of claim 1, wherein the beams pass through two or three dimensions through the sampling zone.

7. An efficient combustion system having a furnace for creating flue gasses, comprising:
an upstream optical monitoring device for sampling the flue gasses and for a first constituent, capable of creating an upstream concentration signal indicating the concentration of the first constituent in the flue gas at its location;
a downstream optical monitoring device for sampling the flue gasses and for the first constituent, capable of creating a downstream concentration signal indicating the concentration of the first constituent in the flue gas at its location;
an emission control device located between, and coupled to the monitoring devices, the emission control device capable of receiving flue gasses and reducing the concentration of the first constituent in the flue gasses, the emission control device receiving the upstream concentration signal and using it to adjust its future operation on future flue gas concentrations to be received, and using the downstream concentration signal to adjust its current operation.

8. The efficient combustion system of claim 7, further comprising:
a second upstream monitoring device for sampling the flue gasses and for a second constituent, capable of creating a second upstream concentration signal indicating the concentration of the second constituent in the flue gas at its location;
a second downstream monitoring device for sampling the flue gasses for the second constituent, capable of creating a second downstream concentration signal indicating the concentration of the second constituent in the flue gas at its location;
a second emission control device located between, and coupled to the second upstream monitoring device and the second downstream monitoring device, the emission control device capable of reducing the concentration of the second constituent in the flue gasses, the second emission control device receiving the second upstream concentration signal and using it to adjust its future operation on future flue gas concentrations of the second constituent to be received, and using the downstream concentration signal to adjust its current operation.

9. The efficient combustion system of claim 7, wherein the first constituent is selected from the group consisting of:
sulfur dioxide (SO₂), sulfur trioxide (SO₃), nitrogen dioxide (NO₂), nitrogen trioxide (NO₃), mercury (Hg) and carbon dioxide (CO₂) mercury (Hg) and suspended particulates.

10. The efficient combustion system of claim 8, wherein the second constituent is selected from the group consisting of:
sulfur dioxide (SO₂), sulfur trioxide (SO₃), nitrogen dioxide (NO₂), nitrogen trioxide (NO₃), mercury (Hg) and carbon dioxide (CO₂) mercury (Hg) and suspended particulates.

11. The efficient combustion system of claim 7, wherein the emission control device is selected from the group consisting of:
NOₓ removal system, SOₓ removal system, mercury removal system, CO₂ removal system and particulate removal system.

12. The efficient combustion system of claim 8, wherein the second emission control device is selected from the group consisting of:
NOₓ removal system, SOₓ removal system, mercury removal system, CO₂ removal system and particulate removal system.

13. The efficient combustion system of claim 11, wherein the NOₓ removal system comprises:
an injector for storing and providing an NOₓ reactant being a material which reduces NOx in flue gasses;
an SCR/SNCR chamber adapted to receive the flue gas and the NOₓ reactant from the injector causing them to interact;
a control unit coupled to the injector and the monitoring devices, the control unit adapted to receive the upstream constituent concentration signal and the downstream constituent concentration signal and cause the injector to inject the proper amount of NOₓ reactant into the SCR/SNCR chamber causing a reaction which removes NOₓ from the flue gasses.

14. The efficient combustion system of claim 11, wherein the SOₓ removal system comprises:
an injector for storing and providing an SOₓ reactant being a material which reduces SOₓ concentration in flue gasses;
an scrubber tank adapted to receive the flue gas and the SOₓ reactant from the injector 440 causing them to interact;
a control unit coupled to the injector and the monitoring devices, the control unit adapted to receive the upstream constituent concentration signal and the downstream constituent concentration signal and cause the injector to inject the proper amount of SOₓ reactant into the scrubber tank causing a reaction which removes SOₓ from the flue gasses.

15. The combustion system of claim 11, wherein the mercury removal system comprises:
an injector for storing and providing an adsorbent;
a mercury removal chamber adapted to receive the flue gas and the adsorbent from the injector causing them to interact;
a control unit coupled to the injector and the monitoring devices, the control unit adapted to receive the upstream constituent concentration signal and the downstream constituent concentration signal and cause the injector to inject the proper amount of adsorbent into the mercury removal chamber causing mercury to be removed from the flue gasses.

16. The efficient combustion system of claim 11, wherein the CO₂ removal system comprises:
an injector for storing and providing a CO₂ reactant being a material which reduces CO₂ in flue gasses;
a CO₂ removal chamber adapted to receive the flue gas and the CO₂ reactant from the injector causing them to interact;
a control unit coupled to the injector and the monitoring devices the control unit adapted to receive the upstream constituent concentration signal and the downstream constituent concentration signal and cause the injector to inject the proper amount of CO₂ reactant into the CO₂ removal chamber causing CO₂ to be removed from the flue gasses.

17. An efficient combustion system comprising:
a furnace for creating flue gasses;
a plurality of serially connected emission control devices connected by ducts each for receiving and processing the flue gasses produced by the furnace;
a control unit for controlling fuel flow, primary air and secondary air to the furnace;
at least one monitoring device having a plurality of optical sources, each optical source passing an optical beam through the flue gasses to a corresponding detector, to create a plurality of sensed signals, the sensed signals being combined to provide a signal indicating the concentration of a constituent in the flue gasses, the monitoring system sending the combined signal to the control unit to control furnace to minimize the concentration of the constituent emitted in the flue gasses.

18. The efficient combustion system of claim 17 wherein the constituent is selected from the group consisting of: NOₓ and mercury.

19. The efficient combustion system of claim 17 wherein the monitoring device is further adapted to send a feedback signal to an upstream emission control system adapted to remove the constituent sensed by optical monitoring device, causing the emission control device to adjust its current operation.

20. The efficient combustion system of claim 17 wherein the monitoring device is further adapted to send a feed forward signal to a downstream emission control system adapted to remove the constituent sensed by optical monitoring device, providing the emission control device advance notice of how to adjust its future operation.

21. The efficient combustion system of claim 17 wherein the monitoring device senses NOx concentrations in the flue gasses and further comprising:
a second monitoring system comprising:
a plurality of optical sources each for passing an optical beam through the flue gasses;
a plurality of detector each receiving the optical beam to create a plurality of sensed signals,
an electronics unit adapted to receive the sensed signals and combined them into a combined signal indicating the concentration of mercury in the flue gasses, the electronics unit adapted to send the combined signal to the control unit,
wherein the control unit is further adapted to receive the combined signals from the monitoring system and the second monitoring system and select operating parameters for furnace to minimize the concentration of both NOₓ and mercury emitted in the flue gasses.
